(19) United States
(12) Patent Application Publication
(10) Pub. No.: US 2011/0158628 A1
(43) Pub. Date: Jun. 30, 2011

(54) AUTOMATIC ADJUSTMENT METHOD OF CAMERA SAFE SHUTTER

(75) Inventors: YU-CHEN HUANG, HSINCHU COUNTY (TW); HSIN-TE WANG, HSINCHU (TW)

(73) Assignee: ALTEK CORPORATION, Hsinchu (TW)

(21) Appl. No.: 12/851,755

(22) Filed: Aug. 6, 2010

(30) Foreign Application Priority Data
Dec. 31, 2009 (TW) 98146214

(51) Int. Cl. G03B 7/083; G03B 7/093

(52) U.S. Cl. 396/246

(57) ABSTRACT

An automatic adjustment method of camera safe shutter includes: count the number of taking pictures with the same exposure time and record their blur degree; determine whether the minimum among the taking pictures counts is arrived at a predetermined threshold, if yes, average all blur degree records which are related with the same exposure time to get an average blur index for each of the exposure times, if no, continue to count the number of taking pictures; determine the average blur indexes whether are all larger than a threshold value, if no, average several slowest exposure times whose average blur indexes are larger than the threshold value as a new safe shutter speed, if yes, select the fastest exposure time level among the levels which are slower than current safe shutter as a new safe shutter speed. Thereby, users can take clear pictures easily.

### BACKGROUND OF THE INVENTION

1. Field of the Invention

The present invention relates to a method for preventing hand shaking when taking pictures. In particular, the present invention relates to an automatic adjustment method of camera safe shutter.

2. Description of Related Art

Because user can see the images after taking pictures by the digital camera immediately, it is more convenient than the traditional camera. The traditional camera has a film, so that it needs to developed. This results in more and more people like to use the digital camera.

Some of the present digital cameras have the functions of detecting the moving objects. They can detect the movement of objects inside camera's view but can not efficiently deal with the vibration generated by the user when presses the shutter bottom. Some of the present digital cameras have the functions of detecting blur, but they only tell users that the blur images are maybe caused by hand shaking after they had taken pictures. The problem of the blur images caused by hand shaking is still not improved.

### SUMMARY OF THE INVENTION

One particular aspect of the present invention is the provision of an automatic adjustment method of camera safe shutter. Which can prevent hand shaking according to users' photographing behavior, and can let users get clear pictures or better image quality.

The automatic adjustment methods of camera safe shutter are as following. Count the number of taking pictures with the same exposure time and record their blur degree. Determine whether the minimum among the taking pictures counts is arrived at a predetermined threshold. If yes, average all blur degree records which are related with the same exposure time to get an average blur index for each of the exposure times. If no, continue to count the number of taking pictures. Determine the average blur indexes whether are all larger than a threshold value. If no, average several slowest exposure times whose average blur indexes are larger than the threshold value as the new safe shutter speed. If yes, select the fastest exposure time level among the levels which are slower than current safe shutter as the new safe shutter speed.

The present invention has useful characteristics beyond traditional cameras:

The present invention is able to provide different safe shutter settings for different users to get their best exposure condition. In this manner, user who has worse handling capacity can use a faster safe shutter setting to get clear pictures easily, and user who has better handling capacity can use a slower safe shutter setting to get better image quality.

For further understanding of the present invention, reference is made to the following detailed description illustrating the embodiments and examples of the present invention. The description is for illustrative purpose only and is not intended to limit the scope of the claims which are the only full description of the scope of this invention.

### BRIEF DESCRIPTION OF THE DRAWINGS

FIG. 1 is a flow chart of the automatic adjustment method of camera safe shutter of the present invention;

FIG. 2 is a curve chart showing the average blur index versus exposure time in the first case of taking pictures;

FIG. 3 is a curve chart showing the average blur index versus exposure time in the second case of taking pictures;

FIG. 4 is another flow chart of the automatic adjustment method of camera safe shutter of the present invention.

### DETAILED DESCRIPTION OF THE PREFERRED EMBODIMENTS

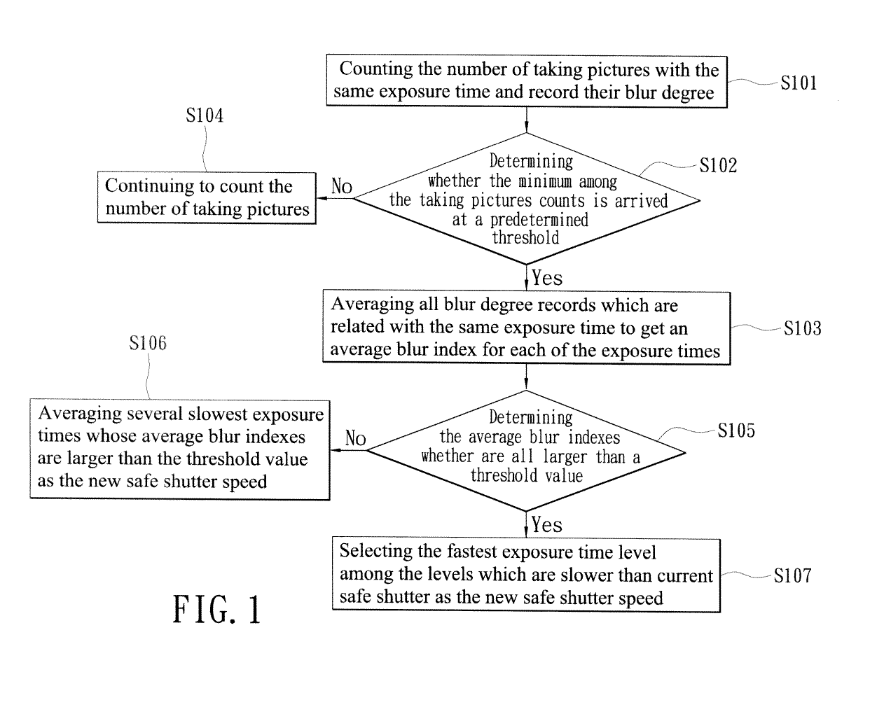

Reference is made to FIG. 1. The present invention provides an automatic adjustment method of camera safe shutter for preventing hand trembling. The method includes step S101 to step S107.

In the step S101, the camera automatically counts the number of taking pictures with the same exposure time and records their blur degree.

In the step S102, the camera automatically determines whether the minimum among the taking pictures counts is arrived at a predetermined threshold. If yes, the camera will run the step S103 described as followings. If no, the camera will run the step S104 described as followings.

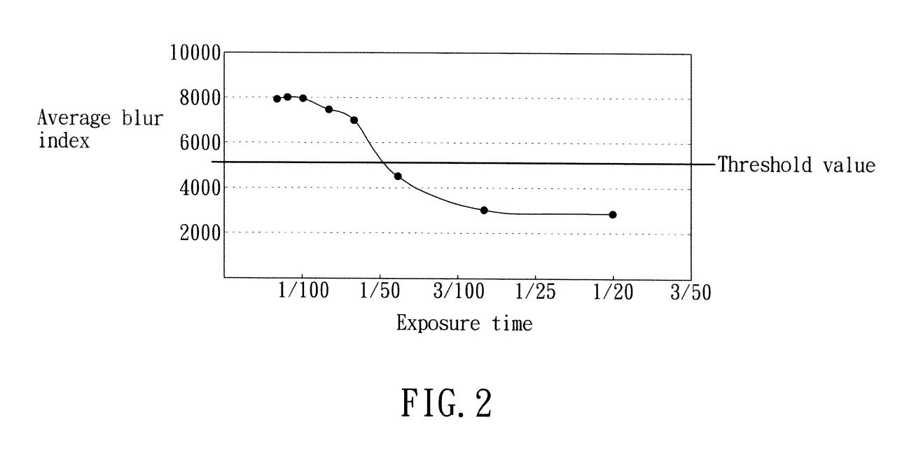

In the step S103, the camera averages all blur degree records which are related with the same exposure time to get an average blur index for each of the exposure times. Connect the average blur indexes in an average blur index versus exposure time chart to form an average blur indexes curve (please refer to FIG. 2). Besides, before the camera averages all blur degree, the camera can reject a specific percentage of maximum blur degree and minimum blur degree for eliminating the cases taking pictures in some special environments or users' unusual operation. For example, the specific percentage is ten percent. The exposure time of 1/50 second has twenty pictures. Ten percent of the twenty pictures are two pictures. As a result, the camera can reject two pictures of the maximum blur degree and two pictures of the minimum blur degree, and then average blur degree of the remaining sixteen pictures.

In the step S104, the camera continues to count the number of taking pictures and record their blur degrees.

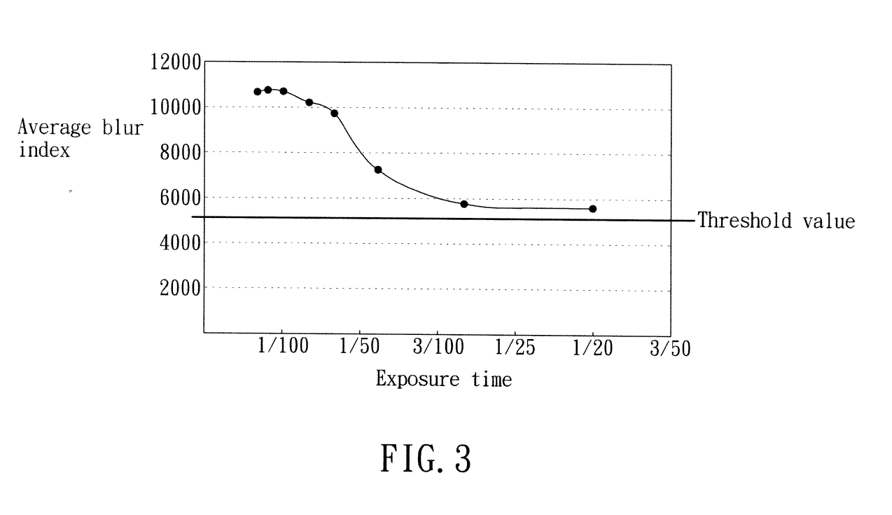

In the step S105, the camera determines the average blur indexes whether are all larger than a threshold value which is set by users. If no (please refer to FIG. 2), the camera will run the step S106 described as followings. If yes (please refer to FIG. 3), the camera will run the step S107 described as followings.

In the step S106, the camera averages several slowest exposure times whose average blur indexes are larger than the threshold value as the new safe shutter speed.

In the step S107, the camera selects the fastest exposure time level among the levels which are slower than current safe shutter as the new safe shutter speed, keeps the current safe shutter, or when the minimum blur index is at least a specific value larger than the blur index threshold value, selects the fastest exposure time level among the levels which are slower than current safe shutter as the new safe shutter speed.

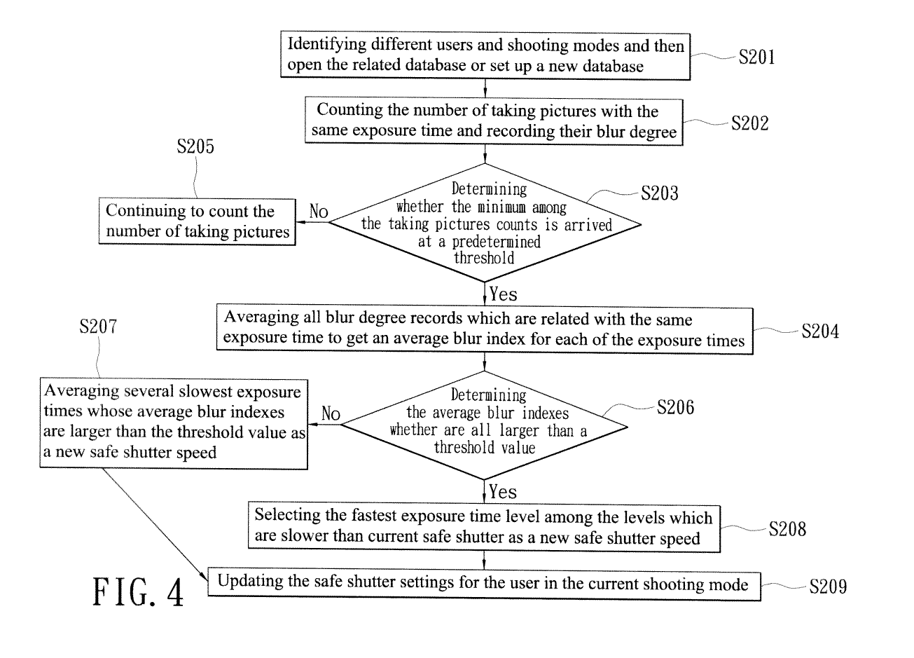

Reference is made to FIG. 4. The present invention further provides an automatic adjustment method of camera safe shutter for different users to set up different safe shutter settings fitting their photographing behavior or for different shooting modes. The young or the photography experts have better handling capacity than the elder or the photography novices so their safe shutter settings are not the same. Consequently, the present invention can set up several independent databases according to different users to count the number of taking pictures and record their blur degrees, and update the safe shutter settings. The same user also can set up independent record database according to the different shooting modes. The automatic adjustment method includes step S201 to step S209 which are described as followings.

In the step S201, the camera can identify different users and shooting modes, and then open the related database which is saved before or set up a new one as a new user or a new shooting mode.

In the step S202, the camera counts the number of taking pictures with the same exposure time and records their blur degree.

In the step S203, the camera determines whether the minimum among the taking pictures counts is arrived at a predetermined threshold, if yes, run the step S204 described as followings, if no, run the step S205 described as followings.

In the step S204, the camera averages all blur degree records which are related with the same exposure time to get an average blur index for each of the exposure times. Connect the average blur indexes in an average blur index versus exposure time chart forms an average blur indexes curve (please refer to FIG. 2). Besides, before the camera averages all blur degree, the camera can reject a specific percentage of maximum blur degree and minimum blur degree for eliminating the cases taking pictures in some special environments or users' unusual operation. For example, the specific percentage is ten percent. The exposure time of 1/50 second has twenty pictures. Ten percent of the twenty pictures are two pictures. As a result, the camera can reject two pictures of the maximum blur degree and two pictures of the minimum blur degree, and then average blur degree of the remaining sixteen pictures.

In the step S205, the camera continues to count the number of taking pictures and record their blur degrees.

In the step S206, the camera determines the average blur indexes whether are all larger than a threshold value which is set by users. If no (please refer to FIG. 2), the camera will run the step S207 described as followings. If yes (please refer to FIG. 3), the camera will run the step S208 described as followings.

In the step S207, the camera averages several slowest exposure times whose average blur indexes are larger than the threshold value as a new safe shutter speed.

In the step S208, the camera selects the fastest exposure time level among the levels which are slower than current safe shutter as a new safe shutter speed, keeps the current safe shutter, or when the minimum blur index is at least a specific value larger than the blur index threshold value, selects the fastest exposure time level among the levels which are slower than current safe shutter as a new safe shutter speed.

In the step S209, the camera updates the safe shutter settings for the user in the current shooting mode according to the step S207 or step S208.

The automatic adjustment method of the present invention has the following characteristics.

1. It can provide different safe shutter settings for different users to prevent hand shaking and get the best exposure condition.

2. The user who has worse handling capacity can get clear pictures easily, and the user who has better handling capacity can get the better image quality.

The description above only illustrates specific embodiments and examples of the present invention. The present invention should therefore cover various modifications and variations made to the herein-described structure and operations of the present invention, provided they fall within the scope of the present invention as defined in the following appended claims.

What is claimed is:

1. An automatic adjustment method of camera safe shutter, comprising:
counting the number of taking pictures with the same exposure time and record their blur degree;
determining whether the minimum among the taking pictures counts is arrived at a predetermined threshold, if yes, averaging all blur degree records which are related with the same exposure time to get an average blur index for each of the exposure times, if no, continuing to count the number of taking pictures; and
determining the average blur indexes whether are all larger than a threshold value, if no, averaging several slowest exposure times whose average blur indexes are larger than the threshold value as the new safe shutter speed, if yes, selecting the fastest exposure time level among the levels which are slower than current safe shutter as the new safe shutter speed.

2. The automatic adjustment method as claimed in claim 1, wherein before count the number of taking pictures, further identify different users, and then open the related database or set up a new database.

3. The automatic adjustment method as claimed in claim 1, wherein before count the number of taking pictures, further identify different shooting modes, and then open the related database or set up a new database.

4. The automatic adjustment method as claimed in claim 1, wherein if the average blur indexes are all larger than the threshold value, keep the current camera safe shutter.

5. The automatic adjustment method as claimed in claim 1, wherein if the average blur indexes are all larger than the threshold value, and when the minimum blur index is at least a specific value larger than the blur index threshold value, select the fastest exposure time level among the levels which are slower than current safe shutter as a new safe shutter speed.

6. The automatic adjustment method as claimed in claim 1, wherein before average all blur degree, further reject a specific percentage of maximum blur degree and minimum blur degree.

7. The automatic adjustment method as claimed in claim 1, wherein after determining the average blur indexes whether are all larger than a threshold value, the camera updates the safe shutter settings for the user in the current shooting mode according to the result.
